(19) United States
(12) Patent Application Publication
(10) Pub. No.: US 2024/0281697 A1
(43) Pub. Date: Aug. 22, 2024

(54) ADAPTED MODEL FEATURE REGISTRY FOR FOUNDATION MODELS

(71) Applicant: International Business Machines Corporation, Armonk, NY (US)

(72) Inventors: Kushal S. Patel, Pune (IN); Gandhi Sivakumar, Bentleigh (AU); Sarvesh S. Patel, Pune (IN)

(73) Assignee: International Business Machines Corporation, Armonk, NY (US)

(21) Appl. No.: 18/112,228

(22) Filed: Feb. 21, 2023

(51) Int. Cl. G06N 20/00

(52) U.S. Cl. CPC G06N 20/00

(57) ABSTRACT

By analyzing a dataset usable to train a model to perform a task, metadata of the dataset is generated, the generating performed responsive to receiving the dataset. The dataset is classified into a domain using the metadata and a set of context definitions. Responsive to receiving a request from the model for use of the dataset, the model is caused to be trained using the dataset, the training enabling the model to perform the task.

### BACKGROUND

The present invention relates generally to a method, system, and computer program product for adjusting foundation and adaptive models. More particularly, the present invention relates to a method, system, and computer program product for an adapted model feature registry for foundation models.

A foundation model is a machine learning model trained on a broad range of subject matters and types of data, typically using self-supervision at scale, that can be adapted to a wide range of downstream tasks. Some examples of a foundation model are the pre-trained language models Bidirectional Encoder Representations from Transformers (BERT) and Generative Pre-trained Transformer 3 (GPT-3). An adapted model is adapted from a foundation model, either by priming the foundation model using new data or a new input prompt, or by updating some of the foundation model's parameters to reflect the new data. Thus, an adapted model has been adapted to perform a specific task (e.g., document summarization, recommender systems, question answering, sentiment analysis, image captioning, object recognition, and the like), incorporate information specific to a particular knowledge domain or use case (e.g., by adding medical or chemistry terminology to a generic language model, or updating a model to take into account new political events or evolving slang terms), or implement constraints on model outputs (e.g., to avoid release of private data).

Datasets are typically organized into one or more tables of columns (also called attributes) and rows (also called records). The rows generally represent instances of a type of entity (e.g., customers or stores) and the columns represent types of data stored for a particular row (e.g., customer name, customer address, order number, and the like). Thus, a row-column intersection stores a value of a particular attribute (e.g., “John Doe” in the customer name column of one row).

### SUMMARY

The illustrative embodiments provide a method, system, and computer program product. An embodiment includes a method that generates, by analyzing a dataset usable to train a model to perform a task, metadata of the dataset, the generating performed responsive to receiving the dataset. An embodiment classifies, into a domain using the metadata and a set of context definitions, the dataset. An embodiment causes training of, responsive to receiving a request from the model for use of the dataset, the model using the dataset, the training enabling the model to perform the task.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts an example diagram of a data processing environments in which illustrative embodiments may be implemented;

FIG. 2 depicts a block diagram of an example configuration for an adapted model feature registry for foundation models in accordance with an illustrative embodiment;

FIG. 3 depicts an example of an adapted model feature registry for foundation models in accordance with an illustrative embodiment;

FIG. 4 depicts a continued example of an adapted model feature registry for foundation models in accordance with an illustrative embodiment;

FIG. 5 depicts a flowchart of an example process for an adapted model feature registry for foundation models in accordance with an illustrative embodiment.

### DETAILED DESCRIPTION

The illustrative embodiments recognize that, when new data becomes available for use in model training, models do not have a mechanism to learn that the new data is available for their use. Even if an adapted model is specifically told about, and thus trained using, the new data, other adapted models and the foundation model the adapted model was adapted from, that could also use the new data, do not have a mechanism to learn that the new data is available for their use. One way to overcome this problem is to retrain the foundation model with the new data and have each adapted model based on that foundation model incorporate the retrained foundation model. However, as the new data may not be useful to many of the adapted models, retraining the foundation model and migrating that change to hundreds or thousands of adapted models is often an inefficient use of computing resources. Thus, the illustrative embodiments recognize that, when new data is available for model training, there is a need to communicate the data's availability to models that might be interested in using the data, while not burdening uninterested models.

The illustrative embodiments recognize that the presently available tools or solutions do not address these needs or provide adequate solutions for these needs. The illustrative embodiments used to describe the invention generally address and solve the above-described problems and other problems related to an adapted model feature registry for foundation models.

An embodiment can be implemented as a software application. The application implementing an embodiment can be configured as a modification of an existing model management system, as a separate application that operates in conjunction with an existing model management system, a standalone application, or some combination thereof.

Particularly, some illustrative embodiments provide a method that generates, by analyzing a dataset usable to train a model, metadata of the dataset, classifies the dataset into a domain using the metadata and a set of context definitions, and causes training of, responsive to receiving a request from the model for use of the dataset, the model using the dataset.

An embodiment maintains an asset repository, which includes data about models intending to use the services of the embodiment. In one embodiment, the asset repository includes information about a foundation model and adapted models adapted from the foundation model. In another embodiment, the repository need not include information about a foundation model. The asset repository need not store the models themselves.

An embodiment implements a communications mechanism to communicate to and from models to which the embodiment provides services. Some non-limiting examples of a communications mechanism are a set of messages defined by a message protocol and implemented using one or more message queues. and an application program interface (API).

An embodiment receives a dataset usable to train a model in the asset repository. The dataset is training data, usable to train the model to perform a particular task. In one embodiment, receipt of a new dataset triggers a notice to the repository, which has the option to respond by requesting dataset analysis.

An embodiment analyzes the dataset, generating metadata of the dataset. Metadata is data that describes the dataset. Some non-limiting examples of metadata an embodiment extracts from the dataset are the number of attributes in the dataset and how many records exist for each attribute and the attributes themselves. One embodiment receives other metadata (e.g., a source of the data in the dataset, a text description of the data in the dataset, any restrictions on where or how the dataset is usable, a price for using the dataset) along with the dataset. For example, one dataset might have attributes including name, age, and annual income, so an embodiment uses these attributes as metadata of the dataset.

An embodiment uses the metadata and a set of context definitions to classify the dataset into one or more of a set of predetermined domains. A domain is a subject matter classification of a dataset, and reflects a use case for a dataset. Some non-limiting examples of domains are “customer”, “retail”, “banking”, and “sports”. Note that domains are not mutually exclusive, and a dataset can be classified into more than one domain. For example, a dataset including customer data for a chain of sporting goods stores might be classified into the “customer”, “retail”, and “sports” domains. Context definitions are predefined rules mapping specified attributes or other metadata to a particular domain or domains. For example, one context definition might be that if a dataset attribute includes the word “customer”, this dataset is classified into the “customer” domain. One embodiment examines each attribute in a dataset and uses a set of context definitions to identify one or more domains corresponding to each attribute. An embodiment stores the dataset, tagged with each of the identified domains, in the asset repository. An embodiment also stores the dataset's metadata in the asset repository, for later reference.

An embodiment notifies models in the asset repository of the availability of the new dataset, along with new dataset's domains. One embodiment broadcasts availability of the new dataset to all models in the asset repository. In another embodiment, one or more models in the asset repository register to receive a notification of availability of a dataset, and when a new dataset is received and tagged, the embodiment notifies the models that have registered. In another embodiment, model registration includes a specification of one or more domains a model is interested in receiving, and when a new dataset is received and tagged with one of the domains a model has registered an interest in, the embodiment notifies the models that have registered for that domain. Another embodiment includes a metadata inquiry mechanism, in which a model in the asset repository requests a dataset with metadata matching a specification, and the embodiment notifies the requestor when a dataset with a portion of metadata matching the specification is available for use. For example, a model might request a dataset, specifying that a source of the data in the dataset is Database A, that there are no restrictions on where or how the dataset is usable, and that the price for using the dataset is less than $100. If the metadata of a dataset matches this specification, the embodiment notifies the requestor of the dataset's availability. Other notification methods are also possible and contemplated within the scope of the illustrative embodiments.

An embodiment receives a request from a model for use of the received and classified dataset. In response, an embodiment causes training of the model using the dataset, resulting in an integrated model. Because the dataset is training data usable to train the model to perform a particular task, the integrated model is now enabled to perform that task. If the model being retrained is a foundation model, after retraining an embodiment notifies adapted models adapted from the foundation model of the retraining, and the domain or metadata of the dataset used in the retraining. In response, an adapted model adapted from the retrained foundation model has the option of requesting retraining as well. If an adapted model requests retraining, an embodiment causes retraining of the adapted model using the retrained foundation model. Techniques to train and retrain a base or adapted model, and to incorporate a retrained base model into an adapted model, are presently available. An embodiment causes model retraining upon request because not all models need incorporate all available training data, and not all adapted models need incorporate all changes to their foundation model.

The manner of an adapted model feature registry for foundation models described herein is unavailable in the presently available methods in the technological field of endeavor pertaining to model management. A method of an embodiment described herein, when implemented to execute on a device or data processing system, comprises substantial advancement of the functionality of that device or data processing system in generating, by analyzing a dataset usable to train a model, metadata of the dataset, classifying the dataset into a domain using the metadata and a set of context definitions, and causing training of, responsive to receiving a request from the model for use of the dataset, the model using the dataset.

The illustrative embodiments are described with respect to certain types of models, foundation models, adapted models, datasets, metadata, attributes, domains, repositories, adjustments, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

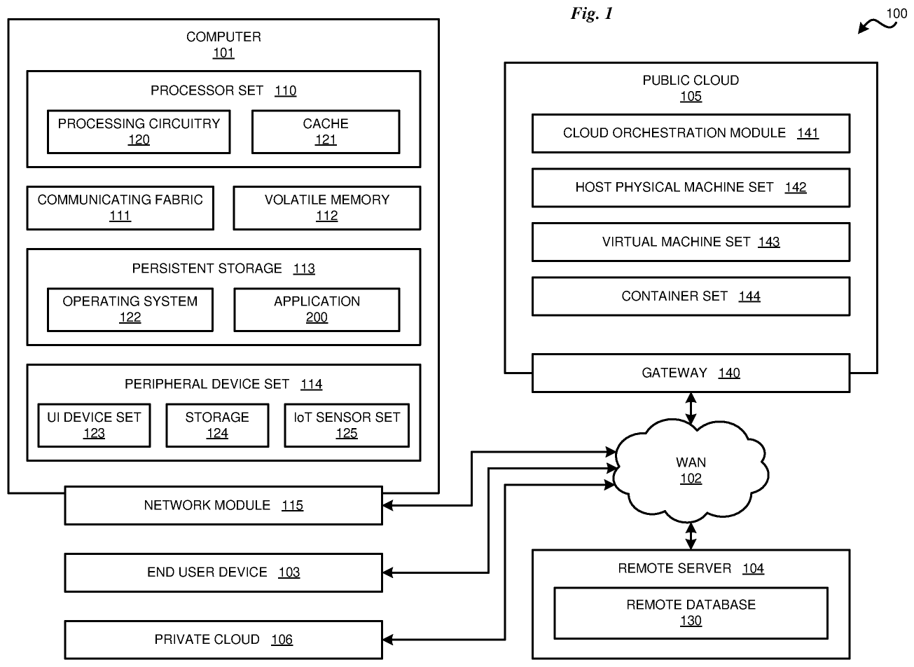

With reference to the figures and in particular with reference to FIG. 1, this figure is an example diagram of a data processing environments in which illustrative embodiments may be implemented. FIG. 1 is only an example and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Computing environment 100 contains an example of an environment for the execution of at least some of the computer code involved in performing the inventive methods, such as application 200. Application 200 implements an adapted model feature registry for foundation models embodiment described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Application 200 executes in any of computer 101, end user device 103, remote server 104, or a computer in public cloud 105 or private cloud 106 unless expressly disambiguated.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processor set 110 may contain one or more processors and may be implemented using one or more heterogeneous processor systems. A processor in processor set 110 may be a single- or multi-core processor or a graphics processor. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Operating system 122 runs on computer 101. Operating system 122 coordinates and provides control of various components within computer 101. Instructions for operating system 122 are located on storage devices, such as persistent storage 113, and may be loaded into at least one of one or more memories, such as volatile memory 112, for execution by processor set 110.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of application 200 may be stored in persistent storage 113 and may be loaded into at least one of one or more memories, such as volatile memory 112, for execution by processor set 110. The processes of the illustrative embodiments may be performed by processor set 110 using computer implemented instructions, which may be located in a memory, such as, for example, volatile memory 112, persistent storage 113, or in one or more peripheral devices in peripheral device set 114. Furthermore, in one case, application 200 may be downloaded over WAN 102 from remote server 104, where similar code is stored on a storage device. In another case, application 200 may be downloaded over WAN 102 to remote server 104, where downloaded code is stored on a storage device.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, user interface (UI) device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Internet of Things (IoT) sensor set 125 is made up of sensors that can be used in IoT applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

Wide area network (WAN) 102 is any WAN (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

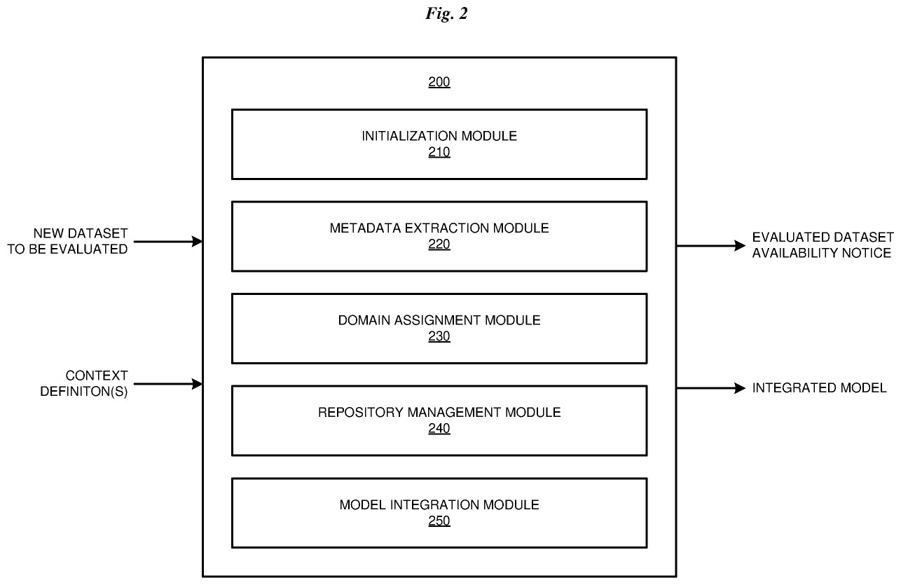

With reference to FIG. 2, this figure depicts a block diagram of an example configuration for an adapted model feature registry for foundation models in accordance with an illustrative embodiment. Application 200 is the same as application 200 in FIG. 1.

Initialization module 210 initializes a communications mechanism used to communicate to and from models to which the embodiment provides services. Module 210 also initializes an asset repository, managed by repository management module 240. The asset repository includes data about models intending to use the services of application 200. In one implementation of application 200, the asset repository includes information about a foundation model and adapted models adapted from the foundation model. In another implementation of application 200, the repository need not include information about a foundation model. The asset repository need not store the models themselves.

Application 200 receives a dataset usable to train a model in the asset repository. The dataset is training data, usable to train the model to perform a particular task. In one implementation, receipt of a new dataset triggers a notice to repository management module 240, which has the option to respond by requesting dataset analysis.

Metadata extraction module 220 analyzes the dataset, generating metadata of the dataset. Some non-limiting examples of metadata module 220 extracts from the dataset are the number of attributes in the dataset and how many records exist for each attribute and the attributes themselves. One implementation of module 220 receives other metadata (e.g., a source of the data in the dataset, a text description of the data in the dataset, any restrictions on where or how the dataset is usable, a price for using the dataset) along with the dataset. For example, one dataset might have attributes including name, age, and annual income, so module 220 uses these attributes as metadata of the dataset.

Domain assignment module 230 uses the metadata and a set of context definitions to classify the dataset into one or more of a set of predetermined domains. A domain is a subject matter classification of a dataset, and reflects a use case for a dataset. Some non-limiting examples of domains are “customer”, “retail”, “banking”, and “sports”. Note that domains are not mutually exclusive, and a dataset can be classified into more than one domain. For example, a dataset including customer data for a chain of sporting goods stores might be classified into the “customer”, “retail”, and “sports” domains. Context definitions are predefined rules mapping specified attributes or other metadata to a particular domain or domains. For example, one context definition might be that if a dataset attribute includes the word “customer”, this dataset is classified into the “customer” domain. One implementation of module 230 examines each attribute in a dataset and uses a set of context definitions to identify one or more domains corresponding to each attribute. Repository management module 240 stores the dataset, tagged with each of the identified domains, in the asset repository. Module 240 also stores the dataset's metadata in the asset repository, for later reference.

Repository management module 240 notifies models in the asset repository of the availability of the new dataset, along with new dataset's domains. One implementation of module 240 broadcasts availability of the new dataset to all models in the asset repository. In another implementation of module 240, one or more models in the asset repository register to receive a notification of availability of a dataset, and when a new dataset is received and tagged, the implementation notifies the models that have registered. In another implementation of module 240, model registration includes a specification of one or more domains a model is interested in receiving, and when a new dataset is received and tagged with one of the domains a model has registered an interest in, the implementation notifies the models that have registered for that domain. Another implementation of module 240 includes a metadata inquiry mechanism, in which a model in the asset repository requests a dataset with metadata matching a specification, and the implementation notifies the requestor when a dataset with a portion of metadata matching the specification is available for use. For example, a model might request a dataset, specifying that a source of the data in the dataset is Database A, that there are no restrictions on where or how the dataset is usable, and that the price for using the dataset is less than $100. If the metadata of a dataset matches this specification, the implementation notifies the requestor of the dataset's availability. Other notification methods are also possible.

Application 200 receives a request from a model for use of the received and classified dataset. In response, model integration module 250 causes training of the model using the dataset, resulting in an integrated model. Because the dataset is training data usable to train the model to perform a particular task, the integrated model is now enabled to perform that task. If the model being retrained is a foundation model, after retraining module 250 notifies adapted models adapted from the foundation model of the retraining, and the domain or metadata of the dataset used in the retraining. In response, an adapted model adapted from the retrained foundation model has the option of requesting retraining as well. If an adapted model requests retraining, module 250 causes retraining of the adapted model using the retrained foundation model.

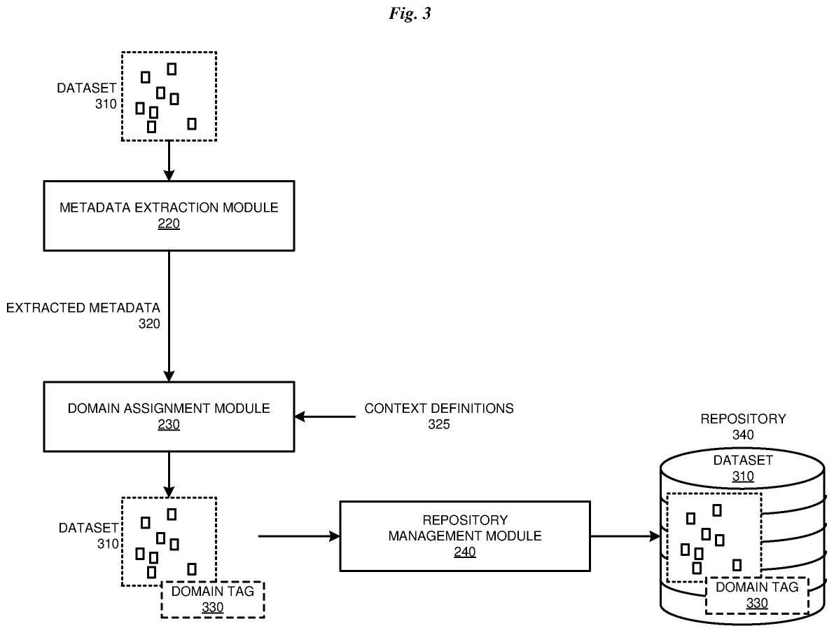

With reference to FIG. 3, this figure depicts an example of an adapted model feature registry for foundation models in accordance with an illustrative embodiment. The example can be executed using application 200 in FIG. 2. Metadata extraction module 220, domain assignment module 230, and repository management module 240 are the same as metadata extraction module 220, domain assignment module 230, and repository management module 240 in FIG. 2.

Application 200 receives dataset 310, a dataset usable to train a model in the asset repository. Metadata extraction module 220 analyzes dataset 310, generating extracted metadata 320. Domain assignment module 230 uses metadata 320 and context definitions 325 to classify dataset 310 into one or more of a set of predetermined domains, generating domain tag 330 for dataset 310. Repository management module 240 stores dataset 310, tagged with domain tag 330, in repository 340.

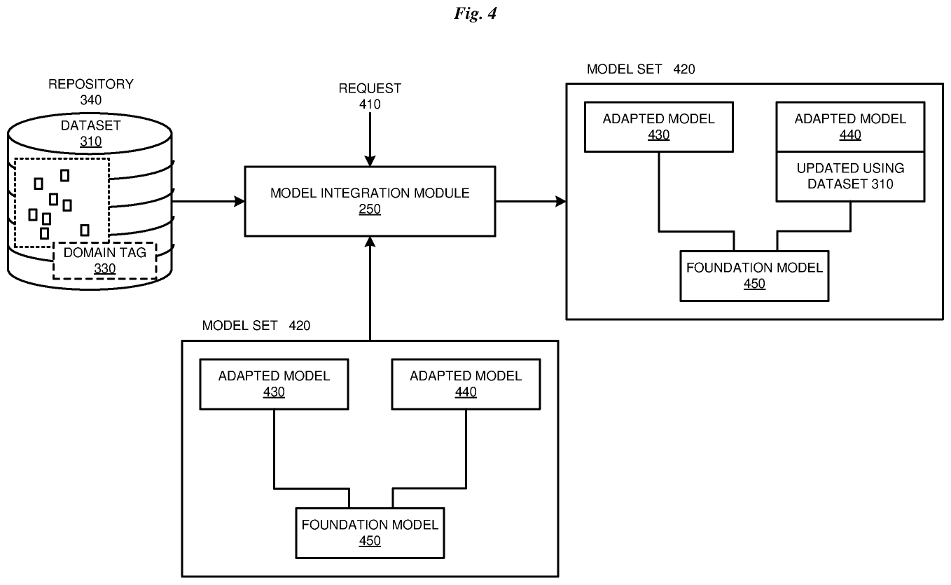

With reference to FIG. 4, this figure depicts a continued example of an adapted model feature registry for foundation models in accordance with an illustrative embodiment. Model integration module 250 is the same as model integration module 250 in FIG. 2. Dataset 310, domain tag 330, and repository 340 are the same as dataset 310, domain tag 330, and repository 340 in FIG. 3.

Application 200 receives request 410, a request from adapted model 440 for use of the received and classified dataset. Model set 420 includes adapted models 430 and 440, both adapted from foundation model 450 (also in model set 420). In response, model integration module 250 causes updating of model 440 using dataset 310, resulting in an updated version of model 450.

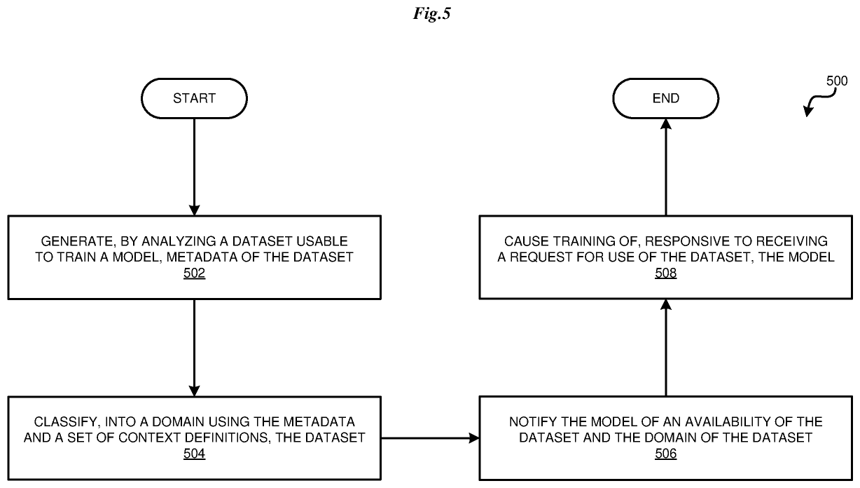

With reference to FIG. 5, this figure depicts a flowchart of an example process for an adapted model feature registry for foundation models in accordance with an illustrative embodiment. Process 500 can be implemented in application 200 in FIG. 2.

In block 502, the application generates, by analyzing a dataset usable to train a model, metadata of the dataset. In block 504, the application classifies, into a domain using the metadata and a set of context definitions, the dataset. In block 506, the application notifies the model of an availability of the dataset and the domain of the dataset. In block 508, the application causes training of, responsive to receiving a request for use of the dataset, the model. Then the application ends.

Thus, a computer implemented method, system or apparatus, and computer program product are provided in the illustrative embodiments for an adapted model feature registry for foundation models and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

What is claimed is:

1. A computer-implemented method comprising:
generating, by analyzing a dataset usable to train a model to perform a task, metadata of the dataset, the generating performed responsive to receiving the dataset;
classifying, into a domain using the metadata and a set of context definitions, the dataset; and
causing training of, responsive to receiving a request from the model for use of the dataset, the model using the dataset, the training enabling the model to perform the task.

2. The computer-implemented method of claim 1, wherein the model is maintained in an asset repository.

3. The computer-implemented method of claim 1, wherein generating metadata of the dataset comprises extracting, from the dataset, a plurality of attributes of the dataset.

4. The computer-implemented method of claim 1, further comprising:
notifying the model of an availability of the dataset and the domain of the dataset.

5. The computer-implemented method of claim 4, wherein the notifying is performed responsive to a registration, the registration specifying a request, by the model, for notification of the availability.

6. The computer-implemented method of claim 5, wherein the request includes the domain.

7. The computer-implemented method of claim 5, wherein the request includes a metadata specification.

8. A computer program product comprising one or more computer readable storage medium, and program instructions collectively stored on the one or more computer readable storage medium, the program instructions executable by a processor to cause the processor to perform operations comprising:
generating, by analyzing a dataset usable to train a model to perform a task, metadata of the dataset, the generating performed responsive to receiving the dataset;
classifying, into a domain using the metadata and a set of context definitions, the dataset; and
causing training of, responsive to receiving a request from the model for use of the dataset, the model using the dataset, the training enabling the model to perform the task.

9. The computer program product of claim 8, wherein the stored program instructions are stored in a computer readable storage device in a data processing system, and wherein the stored program instructions are transferred over a network from a remote data processing system.

10. The computer program product of claim 8, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

11. The computer program product of claim 8, wherein the model is maintained in an asset repository.

12. The computer program product of claim 8, wherein generating metadata of the dataset comprises extracting, from the dataset, a plurality of attributes of the dataset.

13. The computer program product of claim 8, further comprising:
notifying the model of an availability of the dataset and the domain of the dataset.

14. The computer program product of claim 13, wherein the notifying is performed responsive to a registration, the registration specifying a request, by the model, for notification of the availability.

15. The computer program product of claim 14, wherein the request includes the domain.

16. The computer program product of claim 14, wherein the request includes a metadata specification.

17. A computer system comprising a processor and one or more computer readable storage media, and program instructions collectively stored on the one or more computer readable storage media, the program instructions executable by the processor to cause the processor to perform operations comprising:
generating, by analyzing a dataset usable to train a model to perform a task, metadata of the dataset, the generating performed responsive to receiving the dataset;
classifying, into a domain using the metadata and a set of context definitions, the dataset; and
causing training of, responsive to receiving a request from the model for use of the dataset, the model using the dataset, the training enabling the model to perform the task.

18. The computer system of claim 17, wherein the model is maintained in an asset repository.

19. The computer system of claim 17, wherein generating metadata of the dataset comprises extracting, from the dataset, a plurality of attributes of the dataset.

20. The computer system of claim 17, further comprising:
notifying the model of an availability of the dataset and the domain of the dataset.
